(19) United States
(12) Patent Application Publication
(10) Pub. No.: US 2026/0358648 A1
(43) Pub. Date: Nov. 12, 2026

(54) LIGHT SOURCE MODULE

(71) Applicant: CHAMP VISION DISPLAY INC., MIAO-LI COUNTY (TW)

(72) Inventors: Chin-Ku Liu, Miao-Li County (TW); Chung-Hao Wu, Miao-Li County (TW)

(73) Assignee: CHAMP VISION DISPLAY INC., MIAO-LI COUNTY (TW)

(21) Appl. No.: 19/440,504

(22) Filed: Jan. 5, 2026

(30) Foreign Application Priority Data
Mar. 5, 2025 (CN) 202510255387.3

(51) Int. Cl. G02B 30/60; F21V 8/00; G02B 30/33

(52) U.S. Cl. CPC G02B 30/60; G02B 6/0036; G02B 6/0068; G02B 30/33

(57) ABSTRACT

A light source module, including a light guide plate, a first and a second light source, and first and second optical microstructures. The first and second optical microstructures, corresponding to the first and the second light sources respectively, are disposed on a bottom surface of the light guide plate, each having a pattern reflective surface and an off-axis reflective surface facing the first and the second light sources respectively. A pattern reflective angle between the pattern reflective surface and a virtual extension surface of the bottom surface is greater than or equal to 25 degrees and less than or equal to 60 degrees. An off-axis reflective angle between the off-axis reflective surface and the virtual extension surface is greater than or equal to 10 degrees and less than or equal to 20 degrees. The light source module, having a switchable light-emitting angle range, is adapted to display stereoscopic images.

### CROSS-REFERENCE TO RELATED APPLICATION

This application claims the priority benefit of China application serial no. 202510255387.3, filed on Mar. 5, 2025. The entirety of the above-mentioned patent application is hereby incorporated by reference herein and made a part of this specification.

### BACKGROUND

### Technical Field

The disclosure relates to an optical module, and in particular to a light source module.

### Description of Related Art

With advancements in lighting technology, in addition to general lamps that provide illumination functions, decorative lighting panels have been developed to create decorative effects. Such decorative lighting panels have optical microstructures formed on the bottom surface of a light guide plate. The positions of the optical microstructures and the angles of their reflective surfaces are arranged according to the desired effect of the decorative lighting panel. Light emitted from a light source enters through the side surface (light incident surface) of the light guide plate and is reflected by the optical microstructures, allowing the light to be transmitted toward and emitted from the light-emitting surface of the light guide plate. As a result, a user may view patterns or text formed by the light on one side of the light-emitting surface of the light guide plate.

In recent years, to improve the visual experience of viewers, the demand for using decorative lighting panels to display more vivid images has gradually increased. A technique has been proposed that utilizes multiple optical microstructures to guide the light emitted from point light sources toward different viewing angles. Although this technique allows users to see different images from different viewing angles, the light emission angle of the light source limits the size of the patterns that may be displayed and causes the display brightness to be relatively low.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the disclosure was acknowledged by a person of ordinary skill in the art.

### SUMMARY

In order to achieve one, a part, or all of the aforementioned objectives or other objectives, an embodiment of the disclosure provides a light source module. The light source module includes a light guide plate, a first light source, a second light source, multiple first optical microstructures, and multiple second optical microstructures. The light guide plate has a bottom surface and a first light incident surface and a second light incident surface that are connected to the bottom surface and relative to each other. The first light source is disposed on a side of the first light incident surface of the light guide plate. The second light source is disposed on a side of the second light incident surface of the light guide plate. The first optical microstructures are disposed on the bottom surface of the light guide plate and respectively have a first pattern reflective surface facing the first light source and a first off-axis reflective surface facing the second light source. A first pattern reflective angle is included between the first pattern reflective surface and a virtual extension surface of the bottom surface. A first off-axis reflective angle is included between the first off-axis reflective surface and the virtual extension surface of the bottom surface. The second optical microstructures are disposed on the bottom surface of the light guide plate and respectively have a second pattern reflective surface facing the second light source and a second off-axis reflective surface facing the first light source. A second pattern reflective angle is included between the second pattern reflective surface and the virtual extension surface of the bottom surface. A second off-axis reflective angle is included between the second off-axis reflective surface and the virtual extension surface of the bottom surface. The first pattern reflective angle and the second pattern reflective angle are greater than or equal to 25 degrees and less than or equal to 60 degrees. The first off-axis reflective angle and the second off-axis reflective angle are greater than or equal to 10 degrees and less than or equal to 20 degrees.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

FIG. 1 is a bottom view schematic diagram of a light source module according to a first embodiment of the disclosure.

FIG. 2 is a cross-sectional schematic diagram of the light source module of FIG. 1.

FIG. 3 is a light emission distribution diagram of the light source module of FIG. 1 when both the first light source and the second light source are enabled.

FIG. 4A is a schematic diagram of a first viewing angle pattern formed by the first optical microstructures of FIG. 1.

FIG. 4B is a schematic diagram of a second viewing angle pattern formed by the second optical microstructures of FIG. 1.

FIG. 5A is an enlarged schematic diagram of the optical microstructures of FIG. 1.

FIGS. 5B and 5C are enlarged schematic diagrams of other modified embodiments of the optical microstructures of FIG. 1.

FIG. 6 is a bottom view schematic diagram of a light source module according to a second embodiment of the disclosure.

FIG. 7 is a cross-sectional schematic diagram of the light source module of FIG. 6.

FIG. 8A is a schematic diagram of a first viewing angle pattern formed by the first optical microstructures of FIG. 6.

FIG. 8B is a schematic diagram of a second viewing angle pattern formed by the second optical microstructures of FIG. 6.

FIG. 8C is a schematic diagram of a third viewing angle pattern formed by the third optical microstructures of FIG. 6.

FIG. 8D is a schematic diagram of a fourth viewing angle pattern formed by the fourth optical microstructures of FIG. 6.

FIGS. 9A and 9B are cross-sectional schematic diagrams of a light source module according to a third embodiment of the disclosure.

FIG. 10 is a cross-sectional schematic diagram of a light source module according to a fourth embodiment of the disclosure.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

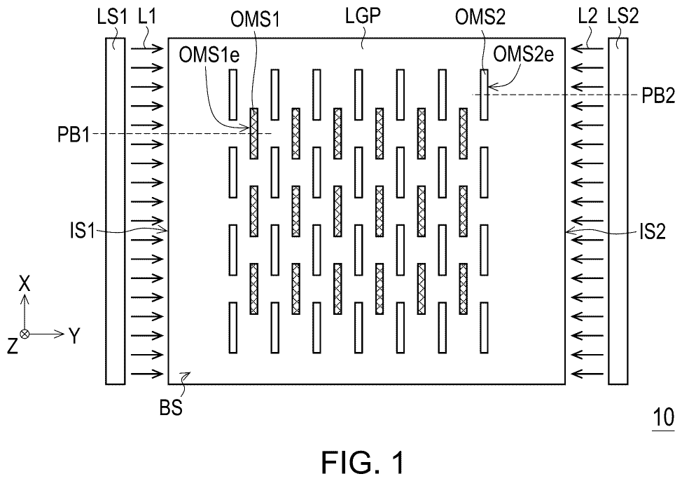

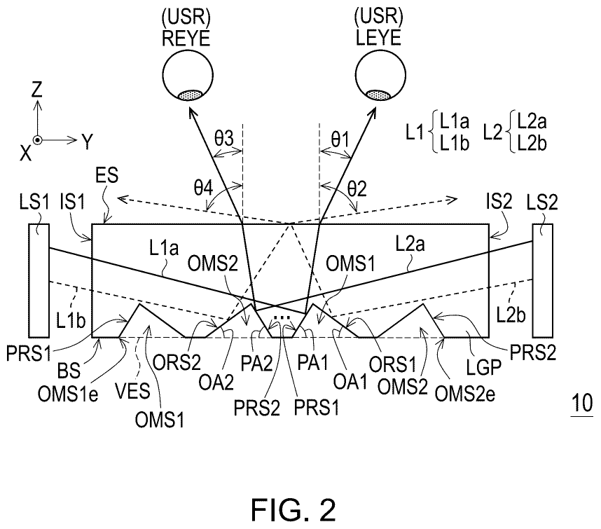

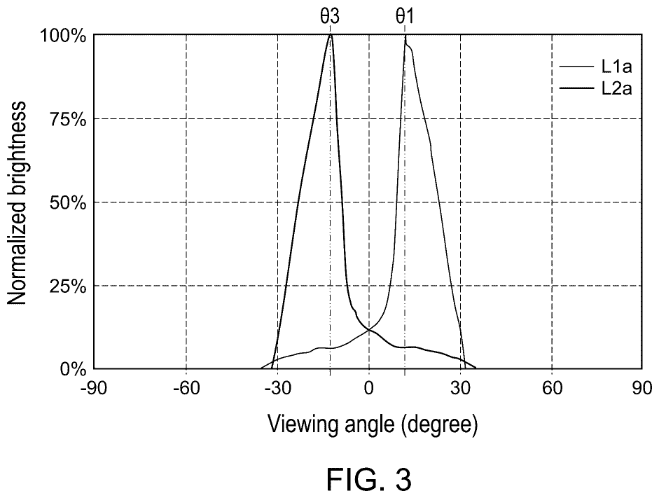

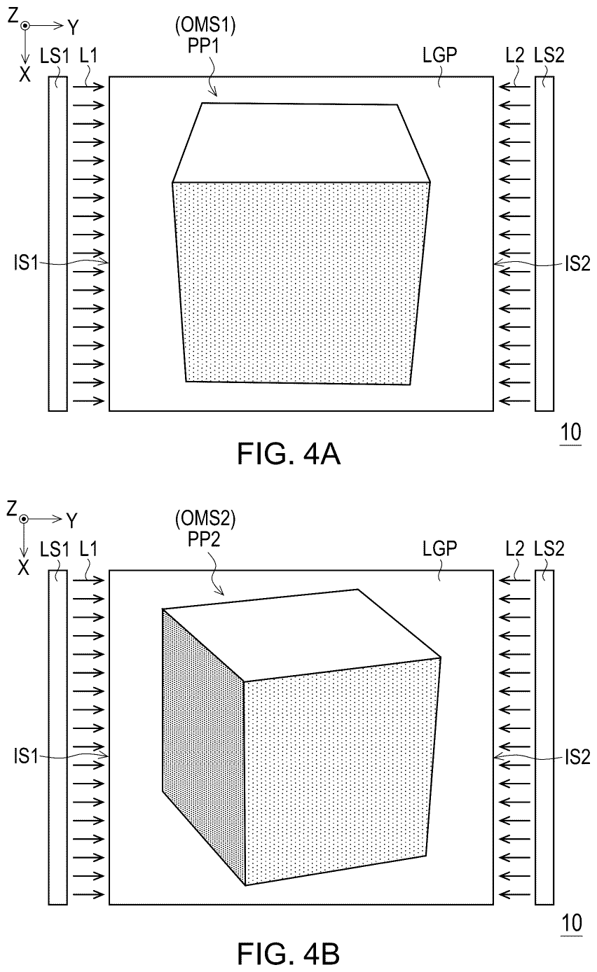

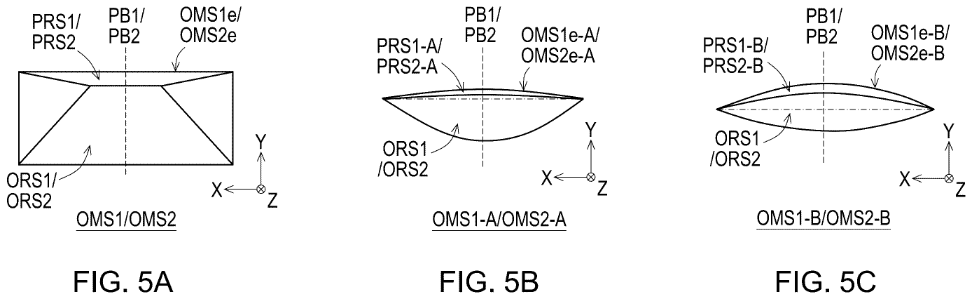

FIG. 1 is a bottom view schematic diagram of a light source module according to a first embodiment of the disclosure. FIG. 2 is a cross-sectional schematic diagram of the light source module of FIG. 1. FIG. 3 is a light emission distribution diagram of the light source module of FIG. 1 when both the first light source and the second light source are illuminated. FIG. 4A is a schematic diagram of a first viewing angle pattern formed by the first optical microstructures of FIG. 1. FIG. 4B is a schematic diagram of a second viewing angle pattern formed by the second optical microstructures of FIG. 1. FIG. 5A is an enlarged schematic diagram of the optical microstructures of FIG. 1. FIGS. 5B and 5C are enlarged schematic diagrams of other modified embodiments of the optical microstructures of FIG. 1.

Referring to FIGS. 1 and 2, a light source module 10 includes a light guide plate LGP, a first light source LS1, a second light source LS2, multiple first optical microstructures OMS1, and multiple second optical microstructures OMS2. The light guide plate LGP has a first light incident surface IS1, a second light incident surface IS2, and a bottom surface BS. The first light incident surface IS1 and the second light incident surface IS2 are relative to each other and are both connected to the bottom surface BS. In this embodiment, the first light incident surface IS1 and the second light incident surface IS2 may be parallel to each other, but are not limited thereto.

The first light source LS1 is disposed on a side of the first light incident surface IS1 of the light guide plate LGP and is used to emit multiple lights L1 toward the first light incident surface IS1. The second light source LS2 is disposed on a side of the second light incident surface IS2 of the light guide plate LGP and is used to emit multiple lights L2 toward the second light incident surface IS2. In this embodiment, the first light source LS1 and the second light source LS2 are, for example, line light sources (such as light strips) and extend in a long-axis direction (such as direction X) of the first light incident surface IS1 or the second light incident surface IS2 of the light guide plate LGP. For example, the line light source may include multiple light-emitting diodes (or other light-emitting elements), and the light-emitting diodes are arranged in a column (strip shape) along the long-axis direction of the first light incident surface IS1 or the second light incident surface IS2.

The first optical microstructures OMS1 and the second optical microstructures OMS2 are disposed on the bottom surface BS of the light guide plate LGP. Preferably, a ratio of an orthographic projection area of the first optical microstructures OMS1 on the bottom surface BS to an area of the bottom surface BS may be less than or equal to 0.8. A ratio of the orthographic projection area of the first optical microstructures OMS1 on the bottom surface BS to an orthographic projection area of the second optical microstructures OMS2 on the bottom surface BS may be greater than 0.8 and less than 1.2. For example, the first optical microstructures OMS1 and the second optical microstructures OMS2 may generally be alternately arranged along a normal direction of the first light incident surface IS1 or the second light incident surface IS2 (such as direction Y), but are not limited thereto.

In this embodiment, the first optical microstructures OMS1 are disposed corresponding to the first light source LS1, and the second optical microstructures OMS2 are disposed corresponding to the second light source LS2. More specifically, the first optical microstructures OMS1 respectively have a first pattern reflective surface PRS1 facing the first light source LS1 and a first off-axis reflective surface ORS1 facing the second light source LS2. The second optical microstructures OMS2 respectively have a second pattern reflective surface PRS2 facing the second light source LS2 and a second off-axis reflective surface ORS2 facing the first light source LS1. A first pattern reflective angle PA1 is included between the first pattern reflective surface PRS1 and a virtual extension surface VES of the bottom surface BS. A first off-axis reflective angle OA1 is included between the first off-axis reflective surface ORS1 and the virtual extension surface VES of the bottom surface BS. A second pattern reflective angle PA2 is included between the second pattern reflective surface PRS2 and the virtual extension surface VES of the bottom surface BS. A second off-axis reflective angle OA2 is included between the second off-axis reflective surface ORS2 and the virtual extension surface VES of the bottom surface BS.

Notably, the first pattern reflective angle PA1 of the first optical microstructures OMS1 is greater than the first off-axis reflective angle OA1, and the second pattern reflective angle PA2 of the second optical microstructures OMS2 is greater than the second off-axis reflective angle OA2. More specifically, the first pattern reflective angle PA1 and the second pattern reflective angle PA2 are both greater than or equal to 25 degrees and less than or equal to 60 degrees, and the first off-axis reflective angle OA1 and the second off-axis reflective angle OA2 are both greater than or equal to 10 degrees and less than or equal to 20 degrees.

For example, the first light source LS1 is adapted to emit a light L1a (i.e., a first light) toward the first pattern reflective surface PRS1 of any of the first optical microstructures OMS1 and to emit a light L1b (i.e., a second light) toward the second off-axis reflective surface ORS2 of any of the second optical microstructures OMS2. The second light source LS2 is adapted to emit a light L2a (i.e., a third light) toward the second pattern reflective surface PRS2 of any of the second optical microstructures OMS2 and to emit a light L2b (i.e., a fourth light) toward the first off-axis reflective surface ORS1 of any of the first optical microstructures OMS1.

The light L1a reflected by the first pattern reflective surface PRS1 is emitted from a light-emitting surface ES at a first emitted angle θ1. The light L1b reflected by the second off-axis reflective surface ORS2 is emitted from the light-emitting surface ES at a second emitted angle θ2. The light L2a reflected by the second pattern reflective surface PRS2 is emitted from the light-emitting surface ES at a third emitted angle θ3. The light L2b reflected by the first off-axis reflective surface ORS1 is emitted from the light-emitting surface ES at a fourth emitted angle θ4. The light-emitting surface ES of the light guide plate LGP is connected to the first light incident surface IS1 and the second light incident surface IS2 and is opposite to the bottom surface BS. The emitted angle is, for example, an angle between the light and a normal direction (such as direction Z) of the light-emitting surface ES.

It is specifically noted that by limiting the angle ranges of the pattern reflective angles and the off-axis reflective angles of the aforementioned optical microstructures, the second emitted angle θ2 of the light L1b may be significantly greater than the first emitted angle θ1 of the light L1a, and the fourth emitted angle θ4 of the light L2b may be significantly greater than the third emitted angle θ3 of the light L2a. More specifically, if a light emitted from the first light source LS1 (such as the light L1a) is incident on the first pattern reflective surface PRS1 of the first optical microstructure OMS1, it will be reflected by the first pattern reflective surface PRS1 into the viewing range of a user USR (such as the viewing angle range of a left eye LEYE). If a light emitted from the first light source LS1 (such as the light L1b) is incident on the second off-axis reflective surface ORS2 of the second optical microstructure OMS2, it will be reflected by the second off-axis reflective surface ORS2 outside the viewing range of the user USR (for example, the second emitted angle θ2 is greater than 45 degrees or greater than 60 degrees). Similarly, if a light emitted from the second light source LS2 (such as the light L2a) is incident on the second pattern reflective surface PRS2 of the second optical microstructure OMS2, it will be reflected by the second pattern reflective surface PRS2 into the viewing range of the user USR (such as the viewing angle range of a right eye REYE). If a light emitted from the second light source LS2 (such as the light L2b) is incident on the first off-axis reflective surface ORS1 of the first optical microstructure OMS1, it will be reflected by the first off-axis reflective surface ORS1 outside the viewing range of the user USR. In this way, it is possible to prevent light emitted from the light sources from being reflected by non-corresponding optical microstructures toward non-corresponding viewing angle directions.

From another perspective, the first optical microstructures OMS1 are adapted to reflect the light L1a from the first light source LS1 toward one eye of the user USR (such as the left eye LEYE) in a direction corresponding to the first emitted angle θ1 (such as the viewing angle shown in FIGS. 2 and 3). The second optical microstructures OMS2 are adapted to reflect the light L2a from the second light source LS2 toward the other eye of the user USR (such as the right eye REYE) in a direction corresponding to the third emitted angle θ3 (such as the viewing angle shown in FIGS. 2 and 3). As shown in FIG. 3, when both the first light source LS1 and the second light source LS2 are enabled, the distribution of the normalized luminance with respect to the viewing angle of the light source module 10 of FIG. 2 is generally concentrated in the viewing angle range corresponding to the first emitted angle θ1 of the light L1a (as shown in FIG. 3, the first emitted angle θ1 is 12 degrees, and the half-width at half-maximum of the light emission range of the light L1a is 15 degrees) and in the viewing angle range corresponding to the third emitted angle θ3 of the light L2a (as shown in FIG. 3, the third emitted angle θ3 is-13 degrees, and the half-width at half-maximum of the light emission range of the light L2a is 15 degrees).

That is, when the user USR is located at a predetermined position, one eye of the user USR may see a distribution pattern of the first optical microstructures OMS1 on the light guide plate LGP through the lights L1a from the respective first optical microstructures OMS1. The other eye of the user USR may see a distribution pattern of the second optical microstructures OMS2 on the light guide plate LGP through the lights L2a from the respective second optical microstructures OMS2. Furthermore, due to the design of the pattern reflective surfaces and the off-axis reflective surfaces of the first optical microstructures OMS1 and the second optical microstructures OMS2, one eye of the user USR will not significantly see the distribution pattern of the second optical microstructures OMS2 on the light guide plate LGP, and the other eye of the user USR will also not significantly see the distribution pattern of the first optical microstructures OMS1 on the light guide plate LGP.

Furthermore, referring to FIGS. 2, 4A, and 4B, for example, the orthographic projection distribution of the first optical microstructures OMS1 on the bottom surface BS may form a first viewing angle pattern PP1 (as shown in FIG. 4A), and the orthographic projection distribution of the second optical microstructures OMS2 on the bottom surface BS may form a second viewing angle pattern PP2 (as shown in FIG. 4B). In this embodiment, the first viewing angle pattern PP1 and the second viewing angle pattern PP2 may have a parallax, meaning that the first viewing angle pattern PP1 and the second viewing angle pattern PP2 represent the same object as seen from different viewing angles. Therefore, when the first viewing angle pattern PP1 and the second viewing angle pattern PP2 are respectively received by the right eye REYE and the left eye LEYE of the user USR, they may be fused by the brain of the user USR to generate a stereoscopic visual effect.

Referring to FIG. 1, in this embodiment, each first pattern reflective surface PRS1 of the first optical microstructures OMS1 has a first edge OMS1e connected to the bottom surface BS. A perpendicular bisector PB1 of the first edge OMS1e is perpendicular to the first light incident surface IS1 of the light guide plate LGP and passes through the first light source LS1. Similarly, each second pattern reflective surface PRS2 of the second optical microstructures OMS2 has a second edge OMS2e connected to the bottom surface BS. A perpendicular bisector PB2 of the second edge OMS2e is perpendicular to the second light incident surface IS2 of the light guide plate LGP and passes through the second light source LS2.

Since the first light source LS1 and the second light source LS2 in this embodiment are line light sources, and the perpendicular bisector of the edge of the pattern reflective surface of each optical microstructure is perpendicular to the corresponding light incident surface, the issue of low display brightness in existing light source modules may be significantly improved. Additionally, the size of the pattern presented by the light source module is no longer restricted.

On the other hand, in this embodiment, the first optical microstructures OMS1 and the second optical microstructures OMS2 are asymmetric elongated structures (asymmetric structures refer to structures in which the pattern reflective angles and the off-axis reflective angles are different, making the optical microstructures asymmetric), as shown in FIG. 5A. However, the disclosure is not limited thereto. In another modified embodiment, to allow light to diffuse in the direction perpendicular to the perpendicular bisector PB1 or the perpendicular bisector PB2, first optical microstructures OMS1-A and second optical microstructures OMS2-A may be asymmetric elongated arc-shaped structures (as shown in FIG. 5B). In this case, the perpendicular bisector of a first edge OMS1e-A of a first pattern reflective surface PRS1-A of the first optical microstructure OMS1-A and the perpendicular bisector of a second edge OMS2e-A of a second pattern reflective surface PRS2-A of the second optical microstructure OMS2-A are, for example, the perpendicular bisectors of the shortest connection between their two endpoints.

In yet another modified embodiment, first optical microstructures OMS1-B and second optical microstructures OMS2-B may be another type of asymmetric elongated arc-shaped structure (as shown in FIG. 5B). In this case, the perpendicular bisector of a first edge OMS1e-B of a first pattern reflective surface PRS1-B of the first optical microstructure OMS1-B and the perpendicular bisector of a second edge OMS2e-B of a second pattern reflective surface PRS2-B of the second optical microstructure OMS2-B are, for example, the perpendicular bisectors of the shortest connection between their two endpoints. The difference between the optical microstructures shown in FIG. 5B and those shown in FIG. 5C lies only in the curvature radius of the edges of the pattern reflective surfaces. For example, the curvature radii of the first edge OMS1e-A and the second edge OMS2e-A in FIG. 5B are each greater than the curvature radii of the first edge OMS1e-B and the second edge OMS2e-B in FIG. 5C.

Some other embodiments will be provided below to describe the disclosure in detail. The same components will be marked with the same reference numerals, and descriptions of the same technical content will be omitted. The omitted parts may be referred to in the previous embodiments and will not be repeated below.

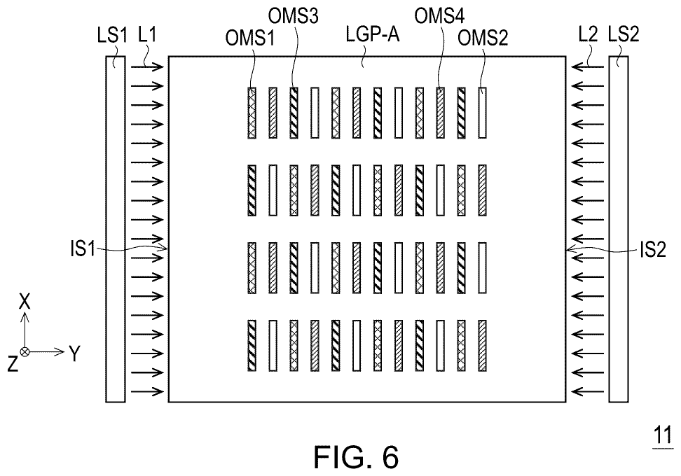

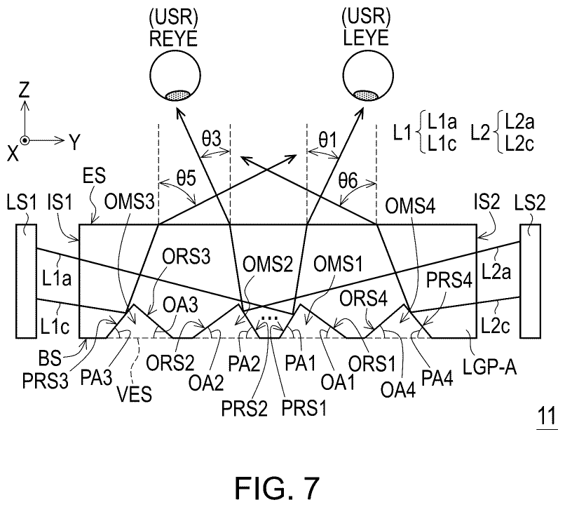

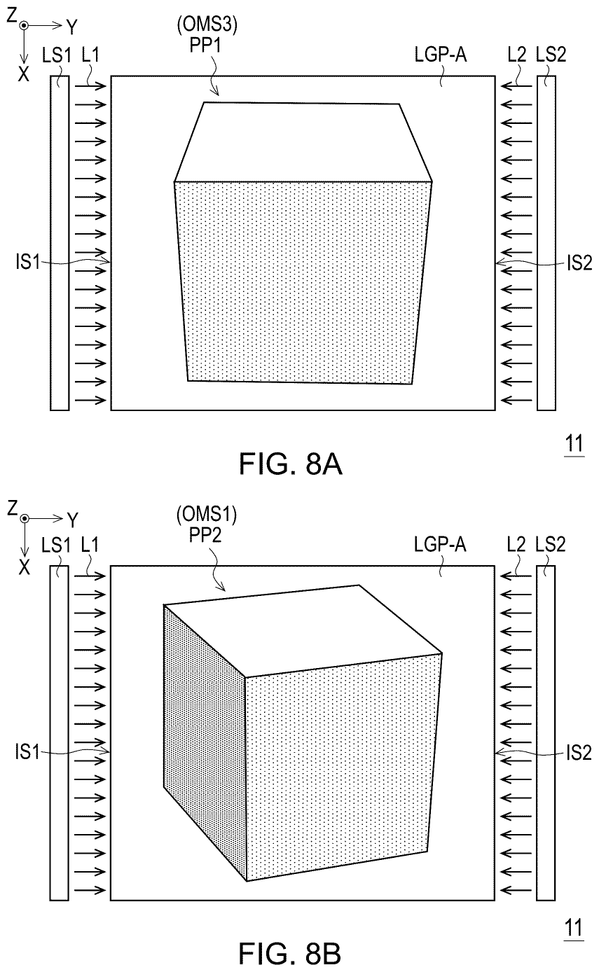

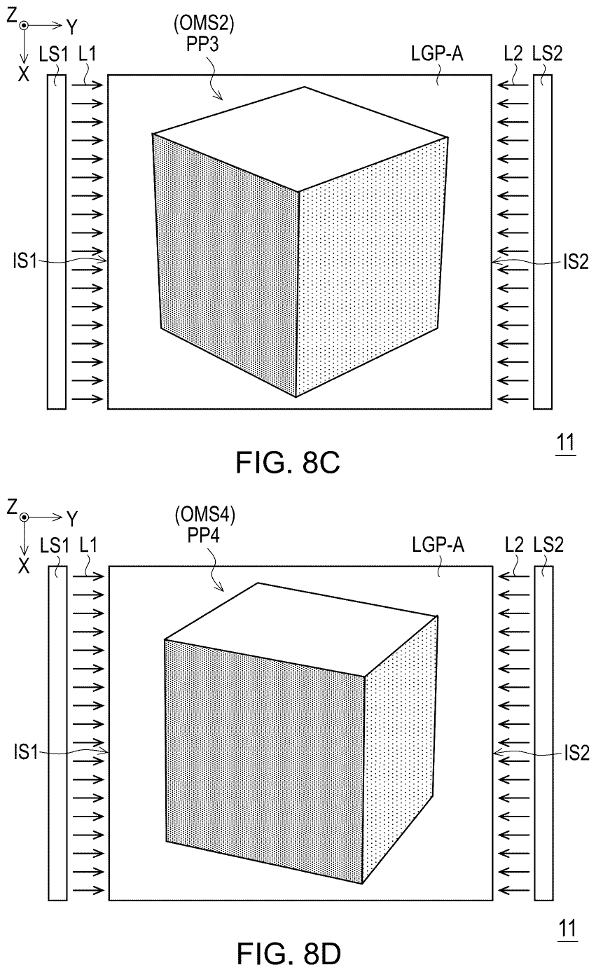

FIG. 6 is a bottom view schematic diagram of a light source module according to a second embodiment of the disclosure. FIG. 7 is a cross-sectional schematic diagram of the light source module of FIG. 6. FIG. 8A is a schematic diagram of a first viewing angle pattern formed by the first optical microstructures of FIG. 6. FIG. 8B is a schematic diagram of a second viewing angle pattern formed by the second optical microstructures of FIG. 6. FIG. 8C is a schematic diagram of a third viewing angle pattern formed by the third optical microstructures of FIG. 6. FIG. 8D is a schematic diagram of a fourth viewing angle pattern formed by the fourth optical microstructures of FIG. 6.

Referring to FIGS. 6 and 7, compared to the light source module 10 shown in FIGS. 1 and 2, a light source module 11 of this embodiment may further include multiple third optical microstructures OMS3 and multiple fourth optical microstructures OMS4, which are disposed on the bottom surface BS of a light guide plate LGP-A. For example, the first optical microstructures OMS1, the second optical microstructures OMS2, the third optical microstructures OMS3, and the fourth optical microstructures OMS4 may generally be alternately arranged along a normal direction of the first light incident surface IS1 or the second light incident surface IS2 (such as direction Y), but are not limited thereto. Since the configuration of the first optical microstructures OMS1 and the second optical microstructures OMS2 on the bottom surface BS in this embodiment is similar to the configuration of the first optical microstructures OMS1 and the second optical microstructures OMS2 of the light source module 10 in FIG. 2, detailed descriptions may be referred to in the relevant paragraphs of the previous embodiments and will not be repeated here.

In this embodiment, the third optical microstructures OMS3 are disposed corresponding to the first light source LS1, and the fourth optical microstructures OMS4 are disposed corresponding to the second light source LS2. More specifically, the third optical microstructures OMS3 respectively have a third pattern reflective surface PRS3 facing the first light source LS1 and a third off-axis reflective surface ORS3 facing the second light source LS2. The fourth optical microstructures OMS4 respectively have a fourth pattern reflective surface PRS4 facing the second light source LS2 and a fourth off-axis reflective surface ORS4 facing the first light source LS1. A third pattern reflective angle PA3 is included between the third pattern reflective surface PRS3 and a virtual extension surface VES of the bottom surface BS. A third off-axis reflective angle OA3 is included between the third off-axis reflective surface ORS3 and the virtual extension surface VES of the bottom surface BS. A fourth pattern reflective angle PA4 is included between the fourth pattern reflective surface PRS4 and the virtual extension surface VES of the bottom surface BS. A fourth off-axis reflective angle OA4 is included between the fourth off-axis reflective surface ORS4 and the virtual extension surface VES of the bottom surface BS.

Notably, the third pattern reflective angle PA3 of the third optical microstructures OMS3 is greater than the third off-axis reflective angle OA3, and the fourth pattern reflective angle PA4 of the fourth optical microstructures OMS4 is greater than the fourth off-axis reflective angle OA4. More specifically, the third pattern reflective angle PA3 and the fourth pattern reflective angle PA4 are both greater than or equal to 25 degrees and less than or equal to 60 degrees, and the third off-axis reflective angle OA3 and the fourth off-axis reflective angle OA4 are both greater than or equal to 10 degrees and less than or equal to 20 degrees.

For example, the first light source LS1 is adapted to emit a light L1c toward the third pattern reflective surface PRS3 of any of the third optical microstructures OMS3, and the second light source LS2 is adapted to emit a light L2c toward the fourth pattern reflective surface PRS4 of any of the fourth optical microstructures OMS4. The light L1c reflected by the third pattern reflective surface PRS3 is emitted from the light-emitting surface ES at a fifth emitted angle θ5. The light L2c reflected by the fourth pattern reflective surface PRS4 is emitted from the light-emitting surface ES at a sixth emitted angle θ6. In this embodiment, the fifth emitted angle θ5 may be greater than the first emitted angle θ1, and the sixth emitted angle θ6 may be greater than the third emitted angle θ3.

Since the third off-axis reflective surface ORS3 of the third optical microstructures OMS3 and the fourth off-axis reflective surface ORS4 of the fourth optical microstructures OMS4 respectively function in relation to the lights from non-corresponding light sources similarly to how the first off-axis reflective surface ORS1 of the first optical microstructures OMS1 and the second off-axis reflective surface ORS2 of the second optical microstructures OMS2 respectively function in relation to the lights from non-corresponding light sources, detailed descriptions may be referred to in the relevant paragraphs of the previous embodiments and will not be repeated here.

In this embodiment, the third pattern reflective surfaces PRS3 of the third optical microstructures OMS3 are capable of reflecting the light L1c from the first light source LS1 toward a first viewing angle. The first pattern reflective surfaces PRS1 of the first optical microstructures OMS1 are capable of reflecting the light L1a from the first light source LS1 toward a second viewing angle. The second pattern reflective surfaces PRS2 of the second optical microstructures OMS2 are capable of reflecting the light L2a from the second light source LS2 toward a third viewing angle. The fourth pattern reflective surfaces PRS4 of the fourth optical microstructures OMS4 are capable of reflecting the light L2c from the second light source LS2 toward a fourth viewing angle.

For example, the aforementioned first viewing angle, second viewing angle, third viewing angle, and fourth viewing angle may be sequentially arranged in the reverse direction of the Y direction shown in FIG. 7. The beam spacing (main beam) between adjacent viewing angles at the position where the beams reach the predetermined movement area of the user USR is approximately equal to the interpupillary distance of the user USR (the distance between the left eye LEYE and the right eye REYE of the user USR). In addition to the binocular positions shown in FIG. 7, if the left eye LEYE of the user USR is positioned at the first viewing angle (i.e., the left eye LEYE is in the emission path of the light L1c), then the right eye REYE will be positioned at the second viewing angle (i.e., the right eye REYE is in the emission path of the light L1a). If the left eye LEYE of the user USR is positioned at the third viewing angle (i.e., the left eye LEYE is in the emission path of the light L2a), then the right eye REYE will be positioned at the fourth viewing angle (i.e., the right eye REYE is in the emission path of the light L2c).

Referring to FIGS. 7 and 8A to 8D, for example, in this embodiment, the orthographic projection distribution of the third optical microstructures OMS3 on the bottom surface BS may form a first viewing angle pattern PP1 (as shown in FIG. 8A). The orthographic projection distribution of the first optical microstructures OMS1 on the bottom surface BS may form a second viewing angle pattern PP2 (as shown in FIG. 8B). The orthographic projection distribution of the second optical microstructures OMS2 on the bottom surface BS may form a third viewing angle pattern PP3 (as shown in FIG. 8C). The orthographic projection distribution of the fourth optical microstructures OMS4 on the bottom surface BS may form a fourth viewing angle pattern PP4 (as shown in FIG. 8D). In this embodiment, the first viewing angle pattern PP1 corresponding to the fifth emitted angle θ5 (i.e., the first viewing angle), the second viewing angle pattern PP2 corresponding to the first emitted angle θ1 (i.e., the second viewing angle), the third viewing angle pattern PP3 corresponding to the third emitted angle θ3 (i.e., the third viewing angle), and the fourth viewing angle pattern PP4 corresponding to the sixth emitted angle θ6 (i.e., the fourth viewing angle) may have a parallax. That is, the first viewing angle pattern PP1, the second viewing angle pattern PP2, the third viewing angle pattern PP3, and the fourth viewing angle pattern PP4 represent the same object as seen from different viewing angles. Therefore, when the first viewing angle pattern PP1 and the second viewing angle pattern PP2 with parallax, the second viewing angle pattern PP2 and the third viewing angle pattern PP3 with parallax, or the third viewing angle pattern PP3 and the fourth viewing angle pattern PP4 with parallax are respectively received by the left eye LEYE and the right eye REYE of the user USR, they may be fused by the brain of the user USR to generate a stereoscopic visual effect.

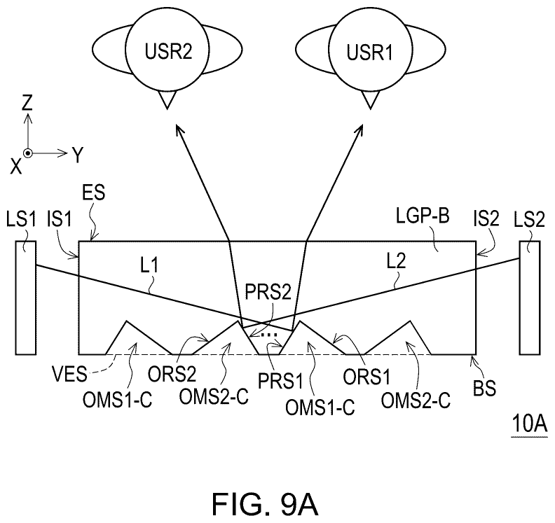

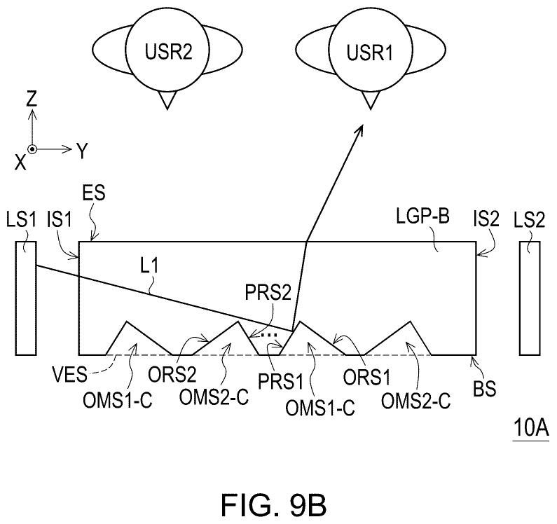

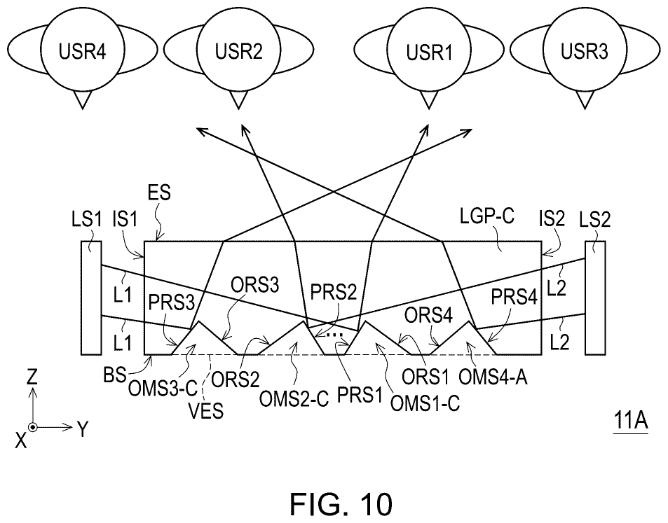

FIGS. 9A and 9B are cross-sectional schematic diagrams of a light source module according to a third embodiment of the disclosure. FIG. 10 is a cross-sectional schematic diagram of a light source module according to a fourth embodiment of the disclosure. Please refer to FIGS. 9A and 9B. The primary difference between a light source module 10A of this embodiment and the light source module 10 of FIG. 2 is the pattern formed by the optical microstructures. Specifically, in the light source module 10A of this embodiment, the orthographic projection distribution of first optical microstructures OMS1-C on the bottom surface BS of a light guide plate LGP-B forms a first pattern, and the orthographic projection distribution of second optical microstructures OMS2-C on the bottom surface BS of the light guide plate LGP-B forms a second pattern. The first pattern is identical to the second pattern. The first pattern and the second pattern may be, for example, the patterns shown in FIG. 4A or FIG. 4B, but are not limited thereto.

In this embodiment, the first pattern reflective surfaces PRS1 of the first optical microstructures OMS1-C are adapted to reflect the light L1 from the first light source LS1 to a user USR1. The second pattern reflective surfaces PRS2 of the second optical microstructures OMS2-C are adapted to reflect the light L2 from the second light source LS2 to a user USR2. Therefore, when both the first light source LS1 and the second light source LS2 are enabled, the user USR1 and the user USR2 may respectively see the identical first pattern and second pattern. At this time, the light source module 10A has a first viewing angle range.

When the first light source LS1 is enabled and the second light source LS2 is disabled, the user USR1 may see the first pattern, but the user USR2 cannot see the second pattern. That is, only the user USR1 may see the pattern presented on the light guide plate LGP-B. In other words, at this time, the light source module 10A has a second viewing angle range, and the first viewing angle range is greater than the second viewing angle range. Therefore, the light source module 10A of this embodiment may adjust its light-emitting angle range by switching the first light source LS1 and the second light source LS2 on and off.

However, the disclosure is not limited thereto. Referring to FIG. 10, in a light source module 11A of another embodiment, a light guide plate LGP-C may further include multiple third optical microstructures OMS3-C and multiple fourth optical microstructures OMS4-C. The orthographic projection distribution of the third optical microstructures OMS3-C on the bottom surface BS of the light guide plate LGP-C forms a third pattern, and the orthographic projection distribution of the fourth optical microstructures OMS4-C on the bottom surface BS of the light guide plate LGP-C forms a fourth pattern. The first pattern, the second pattern, the third pattern, and the fourth pattern are identical to each other. The first pattern to the fourth pattern may be, for example, the patterns shown in FIG. 4A or FIG. 4B, but are not limited thereto.

In this embodiment, the third pattern reflective surfaces PRS3 of the third optical microstructures OMS3-C are adapted to reflect the light L1 from the first light source LS1 to a user USR3. The fourth pattern reflective surfaces PRS4 of the fourth optical microstructures OMS4-C are adapted to reflect the light L2 from the second light source LS2 to a user USR4. Therefore, when both the first light source LS1 and the second light source LS2 are enabled, the users USR1, USR2, USR3, and USR4 may respectively see the identical first pattern, second pattern, third pattern, and fourth pattern. At this time, the light source module 11A has a third viewing angle range, and the third viewing angle range is greater than the first viewing angle range of the light source module 10A in FIG. 9A.

It is understood that when the first light source LS1 is enabled and the second light source LS2 is disabled, the users USR1 and USR3 may respectively see the identical first pattern and third pattern, but the users USR2 and USR4 cannot see the second pattern and the fourth pattern. At this time, the light source module 11A has a fourth viewing angle range, and the fourth viewing angle range is greater than the second viewing angle range of the light source module 10A in FIG. 9B.

In other words, the third optical microstructures OMS3-C and the fourth optical microstructures OMS4-C additionally provided on the light guide plate LGP-C in this embodiment may further increase the light-emitting angle range of the light source module 11A when the first light source LS1 and/or the second light source LS2 is in an enabled state.

In summary, in the light source module of an embodiment of the disclosure, the first light source and the second light source are respectively disposed corresponding to two light incident surfaces of the light guide plate that are relative to each other. The bottom surface of the light guide plate is provided with multiple first optical microstructures disposed corresponding to the first light source and multiple second optical microstructures disposed corresponding to the second light source. Since the angle between the pattern reflective surface of each optical microstructure and the bottom surface is greater when facing the corresponding light source than the angle between the off-axis reflective surface and the bottom surface when facing the non-corresponding light source, the pattern reflective surface of each optical microstructure may direct the light emitted by the corresponding light source toward the desired viewing angle, while the off-axis reflective surface may direct the light emitted by the non-corresponding light source outside the desired viewing angle. Through the corresponding configuration relationship between the two sets of light sources and optical microstructures, the light source module may achieve a stereoscopic image display function or a switchable light-emitting angle range.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A light source module, comprising:
a light guide plate, having a bottom surface and a first light incident surface and a second light incident surface that are connected to the bottom surface and relative to each other;
a first light source, disposed on a side of the first light incident surface of the light guide plate;
a second light source, disposed on a side of the second light incident surface of the light guide plate;
a plurality of first optical microstructures, disposed on the bottom surface of the light guide plate and respectively having a first pattern reflective surface facing the first light source and a first off-axis reflective surface facing the second light source, wherein a first pattern reflective angle is included between the first pattern reflective surface and a virtual extension surface of the bottom surface, and a first off-axis reflective angle is included between the first off-axis reflective surface and the virtual extension surface of the bottom surface; and
a plurality of second optical microstructures, disposed on the bottom surface of the light guide plate and respectively having a second pattern reflective surface facing the second light source and a second off-axis reflective surface facing the first light source, wherein a second pattern reflective angle is included between the second pattern reflective surface and the virtual extension surface of the bottom surface, and a second off-axis reflective angle is included between the second off-axis reflective surface and the virtual extension surface of the bottom surface, wherein the first pattern reflective angle and the second pattern reflective angle are greater than or equal to 25 degrees and less than or equal to 60 degrees, and the first off-axis reflective angle and the second off-axis reflective angle are greater than or equal to 10 degrees and less than or equal to 20 degrees.

2. The light source module according to claim 1, further comprising:
a plurality of third optical microstructures, disposed on the bottom surface of the light guide plate and respectively having a third pattern reflective surface facing the first light source and a third off-axis reflective surface facing the second light source, wherein a third pattern reflective angle is included between the third pattern reflective surface and the virtual extension surface of the bottom surface, and a third off-axis reflective angle is included between the third off-axis reflective surface and the virtual extension surface of the bottom surface, wherein the third pattern reflective angle is greater than the third off-axis reflective angle, and the third pattern reflective angle is different from the first pattern reflective angle of each of the plurality of first optical microstructures.

3. The light source module according to claim 2, further comprising:
a plurality of fourth optical microstructures, disposed on the bottom surface of the light guide plate and respectively having a fourth pattern reflective surface facing the second light source and a fourth off-axis reflective surface facing the first light source, wherein a fourth pattern reflective angle is included between the fourth pattern reflective surface and the virtual extension surface of the bottom surface, and a fourth off-axis reflective angle is included between the fourth off-axis reflective surface and the virtual extension surface of the bottom surface, wherein the fourth pattern reflective angle is greater than the fourth off-axis reflective angle, and the fourth pattern reflective angle is different from the second pattern reflective angle of each of the plurality of second optical microstructures.

4. The light source module according to claim 3, wherein the third pattern reflective angle and the fourth pattern reflective angle are greater than or equal to 25 degrees and less than or equal to 60 degrees, and the third off-axis reflective angle and the fourth off-axis reflective angle are greater than or equal to 10 degrees and less than or equal to 20 degrees.

5. The light source module according to claim 1, wherein the light guide plate further has a light-emitting surface relative to the bottom surface, the first light source is adapted to emit a first light toward the first pattern reflective surface of each of the plurality of first optical microstructures and emit a second light toward the second off-axis reflective surface of each of the plurality of second optical microstructures, the second light source is adapted to emit a third light toward the second pattern reflective surface of the each of the plurality of second optical microstructures and emit a fourth light toward the first off-axis reflective surface of the each of the plurality of first optical microstructures, the first light is reflected by the first pattern reflective surface and emitted from the light-emitting surface at a first emitted angle, the second light is reflected by the second off-axis reflective surface and emitted from the light-emitting surface at a second emitted angle, the third light is reflected by the second pattern reflective surface and emitted from the light-emitting surface at a third emitted angle, and the fourth light is reflected by the first off-axis reflective surface and emitted from the light-emitting surface at a fourth emitted angle, wherein the second emitted angle is greater than the first emitted angle, and the fourth emitted angle is greater than the third emitted angle.

6. The light source module according to claim 1, wherein each the first pattern reflective surface has a first edge connected to the bottom surface, each the second pattern reflective surface has a second edge connected to the bottom surface, a perpendicular bisector of the first edge is perpendicular to the first light incident surface and passes through the first light source, and a perpendicular bisector of the second edge is perpendicular to the second light incident surface and passes through the second light source.

7. The light source module according to claim 1, wherein an orthographic projection distribution of the plurality of first optical microstructures on the bottom surface forms a first viewing angle pattern, an orthographic projection distribution of the plurality of second optical microstructures on the bottom surface forms a second viewing angle pattern, and the first viewing angle pattern and the second viewing angle pattern have a parallax.

8. The light source module according to claim 1, wherein an orthographic projection distribution of the plurality of first optical microstructures on the bottom surface forms a first pattern, an orthographic projection distribution of the plurality of second optical microstructures on the bottom surface forms a second pattern, and the first pattern is identical to the second pattern.

9. The light source module according to claim 8, wherein when both the first light source and the second light source are enabled, the light source module has a first viewing angle range, and when the first light source is enabled and the second light source is disabled, the light source module has a second viewing angle range, the first viewing angle range being greater than the second viewing angle range.
